(19) United States
(12) Patent Application Publication
(10) Pub. No.: US 2024/0192327 A1
(43) Pub. Date: Jun. 13, 2024

(54) DEVICE FOR DISTANCE MEASUREMENT

(71) Applicant: SK hynix Inc., Icheon-si Gyeonggi-do (KR)

(72) Inventors: Sun Young LEE, Icheon-si Gyeonggi-do (KR); Jeong Eun SONG, Icheon-si Gyeonggi-do (KR)

(73) Assignee: SK hynix Inc., Icheon-si Gyeonggi-do (KR)

(21) Appl. No.: 18/337,338

(22) Filed: Jun. 19, 2023

(30) Foreign Application Priority Data
Dec. 7, 2022 (KR) 10-2022-0169698

(51) Int. Cl. G01S 7/481; G01S 17/08

(52) U.S. Cl. CPC G01S 7/4816; G01S 17/08

(57) ABSTRACT

An image sensor includes at least two pixels and a control circuit. The control circuit is configured to provide a first modulation voltage and a second modulation voltage having a phase difference of 180 degrees from each other to each of the at least two pixels in a first mode. The control circuit is also configured to provide the first modulation voltage to a first pixel among the at least two pixels and provide the second modulation voltage to a second pixel among the at least two pixels in a second mode.

### CROSS-REFERENCE TO RELATED APPLICATION

The present application claims priority under 35 U.S.C. § 119(a) to Korean patent application number 10-2022-0169698 filed on Dec. 7, 2022, in the Korean Intellectual Property Office, the entire disclosure of which is incorporated by reference herein.

### BACKGROUND

### 1. Technical Field

The present disclosure relates to a technique for measuring a distance to an external object using a time of flight (TOF) method.

### 2. Related Art

Demand for an image sensor that measures a distance to an external object is increasing in various fields such as security, a medical device, an automobile, a game machine, a VR/AR, a mobile device, and the like. Methods for measuring distance include triangulation, time of flight (hereinafter referred to as TOF), interferometry, and the like. Among them, the TOF method is a method of calculating a distance by measuring a flight time of light or a signal, that is, a time when the light or the signal is reflected and comes from an external object after outputting the light or the signal, and has an advantage of a wide application range, a fast processing speed, and an advantageous cost.

Among the TOF methods, an indirect TOF method may emit a modulated light wave (hereinafter referred to as modulated light) through a light source, and the modulated light may have a sine wave, a pulse train, or other periodic waveform. A TOF sensor detects reflected light in which the modulated light is reflected from a surface of an observed scene. An electronic device calculates a physical distance (or depth) between the TOF sensor and an external object in the scene by measuring a phase difference between the emitted modulated light and the received reflected light.

### SUMMARY

A TOF sensor generates a pixel current in a pixel by applying a modulation voltage to the pixel, and measures a phase difference between modulated light and reflected light by capturing a photo charge moving according to the pixel current. At this time, the pixel current increases as a size of the pixel decreases and/or as a voltage difference between applied modulation voltages increases. However, there is a problem in that when the pixel current is generated at a level equal to or greater than a certain level in the pixel, power consumption of the TOF sensor increases and efficiency of capturing the photo charge decreases compared to a difference between applied voltages. For example, when a pixel size (or a horizontal length or a vertical length of the pixel) is 5 μm or less, as the pixel current is generated at a level equal to or greater than a certain level, distance measurement performance of the TOF sensor may be decreased.

According to an embodiment of the present disclosure, an image sensor may include at least two pixels and a control circuit. The control circuit is configured to provide a first modulation voltage and a second modulation voltage having a phase difference of 180 degrees from each other to each of the at least two pixels in a first mode. The control circuit is also configured to provide the first modulation voltage to a first pixel among the at least two pixels and provide the second modulation voltage to a second pixel among the at least two pixels in a second mode.

According to an embodiment of the present disclosure, a distance measuring method may include outputting modulated light corresponding to a first phase through a light source; generating a photo charge from reflected light in which the modulated light is reflected by an external object, through at least two pixels; providing a first modulation voltage corresponding to the first phase and a second modulation voltage having a phase difference of 180 degrees from the first modulation voltage to each of the at least two pixels in a first mode, or providing the first modulation voltage to a first pixel among the at least two pixels and providing the second modulation voltage to a second pixel among the at least two pixels in a second mode, according to a mode; and determining a distance to the external object using the photo charge captured by the first modulation voltage and the second modulation voltage.

According to the present disclosure, by reducing a pixel current flowing in pixels of a TOF sensor, power consumption of the TOF sensor may be decreased, efficiency in which a photo charge is captured may be increased, and distance measurement performance of the TOF sensor may be improved.

### BRIEF DESCRIPTION OF THE DRAWINGS

FIG. 1 is a diagram schematically illustrating a configuration of an electronic device according to an embodiment of the present disclosure.

FIG. 2 is a diagram illustrating an example of a pixel array according to an embodiment of the present disclosure.

FIG. 3 is a diagram illustrating another example of a pixel array according to an embodiment of the present disclosure.

FIG. 4 is a diagram illustrating a modulation voltage provided to pixels in a first mode according to an embodiment of the present disclosure.

FIG. 5 is a diagram illustrating a modulation voltage provided to pixels in a second mode according to an embodiment of the present disclosure.

FIG. 6 is a diagram illustrating a signal line transferring a modulation voltage to pixels according to an embodiment of the present disclosure.

FIG. 7 is a diagram illustrating a method of reading out pixels in a first mode according to an embodiment of the present disclosure.

FIG. 8 is a diagram illustrating a method of reading out pixels in a second mode according to an embodiment of the present disclosure.

FIG. 9 is a flow diagram illustrating a method of providing a modulation voltage in different methods according to a mode according to an embodiment of the present disclosure.

### DETAILED DESCRIPTION

Specific structural or functional descriptions of embodiments according to the concept which are disclosed in the present specification or application are illustrated only to describe the embodiments according to the concept of the present disclosure. The embodiments according to the concept of the present disclosure may be carried out in various forms and should not be construed as being limited to the embodiments described in the present specification or application.

Hereinafter, embodiments of the present disclosure will be described with reference to the accompanying drawings to describe in detail enough to allow those of ordinary skill in the art to easily implement the technical idea of the present disclosure.

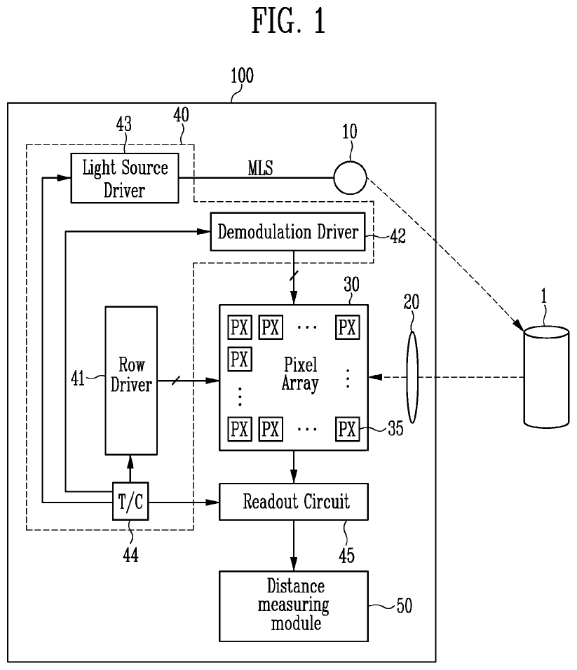

FIG. 1 is a diagram schematically illustrating a configuration of an electronic device according to an embodiment of the present disclosure.

Referring to FIG. 1, the electronic device 100 may measure a distance to an external object 1 using a time of flight (TOF) method. The TOF method may mean a method of emitting modulated light toward the external object 1, sensing reflected light reflected from the external object 1, and indirectly measuring a distance between the electronic device 100 and the external object 1 based on a phase difference between the modulated light and the reflected light.

Referring to FIG. 1, the electronic device 100 may include a light source 10, a lens module 20, a pixel array 30, a control circuit 40, a readout circuit 45, and a distance measuring module 50.

The light source 10 may emit light to the external object 1 in response to a light modulation signal MLS provided from the control circuit 40. The light source 10 may be a combination of a laser diode (LD), a light emitting diode (LED), a near infrared laser (NIR), a point light source, a monochromatic light source in which a white lamp and a monochromator are combined, or a combination of other laser light sources, which emits light of a specific wavelength band (for example, near infrared light, infrared light, or visible light). For example, the light source 10 may emit infrared light having a wavelength of 800 nm to 1000 nm. The light emitted from the light source 10 may be modulated light modulated with a predetermined frequency. That is, the light source 10 may output modulated light corresponding to a first phase. The first phase may be a phase in which an activation voltage (for example, 1.2V) and an inactivation voltage (for example, 0V) are repeated according to a designated period. Although only one light source 10 is shown in FIG. 1 for convenience of description, a plurality of light sources may be arranged around the lens module 20.

The lens module 20 may collect the light reflected from the external object 1 and concentrate the light on pixels 35 of the pixel array 30. The lens module 20 may include a concentration lens or other cylindrical optical element on a glass or a plastic surface. The lens module 20 may include a plurality of lenses aligned around an optical axis.

The pixel array 30 may include a plurality of pixels 35 successively arranged in a two-dimensional matrix structure. For example, the pixel array 30 may include the pixels 35 successively arranged in a row direction and a column direction. The pixel 35 may be a minimum unit in which the same shape is repeatedly arranged on the pixel array 30.

Each of the pixels 35 may be formed on a semiconductor substrate, and each pixel 35 may output a pixel signal by converting light received through the lens module 20 into an electrical signal corresponding to an intensity of the light. The pixel signal may be used to measure the distance between the electronic device 100 and the external object 1.

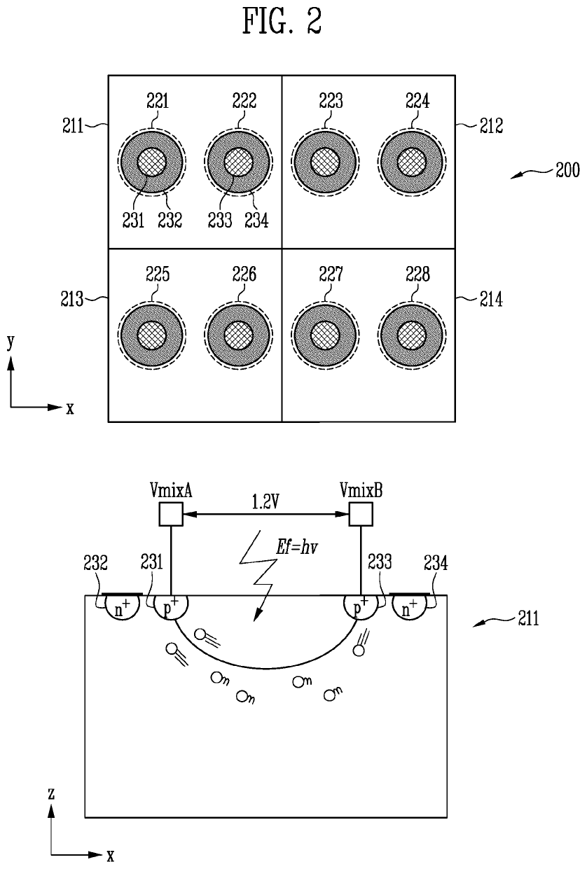

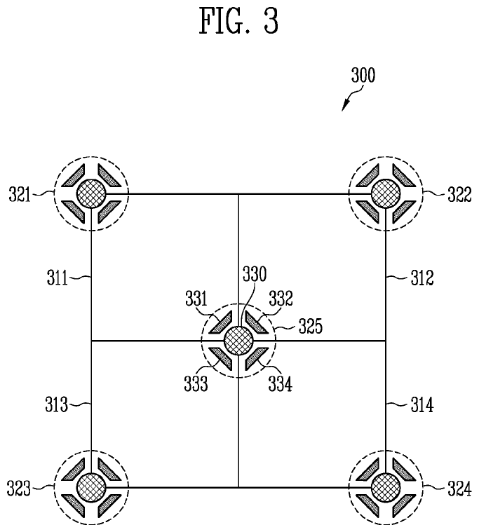

The pixel 35 may be any one of a current-assisted photonic demodulator (CAPD) pixel, a vertical field modulator (VFM) pixel, a gate assisted photonic demodulator (GAPD) pixel, a quantum efficiency modulation (QEM) pixel, or a pinned photodiode (PPD) pixel. For example, when the pixel 35 is the CAPD pixel, the pixel 35 may capture a photo charge generated in a substrate by incident light using a hole current according to a voltage difference. A more detailed structure of each pixel 35 is described later with reference to FIGS. 2 and 3. In addition, for convenience of description, the present disclosure is mainly described on a premise of a CAPD pixel structure, but the technical spirit according to the present disclosure may also be applied to GAPD, QEM, and PPD methods.

The control circuit 40 may include a row driver 41, a demodulation driver 42, a light source driver 43, and a timing controller (T/C) 44.

The control circuit 40 (for example, the row driver 41 and the demodulation driver 42) may drive the pixels 35 of the pixel array 30 in response to a timing signal output from the timing controller 44.

The control circuit (for example, the row driver 41) may generate a control signal capable of selecting and controlling at least one row ling among a plurality of row lines of the pixel array 30. The control signal may include at least a portion of a reset signal for controlling a reset transistor, a transfer signal for controlling transferal of a photo charge accumulated in a detection area, and a select signal for controlling a select transistor.

The control circuit (for example, the demodulation driver 42) may generate and output a drive signal for generating a pixel current (for example, a hole current) in the substrate of the pixels 35. The pixel current may be a current for moving the photo charge generated in the substrate toward the detection area (for example, a tap).

In FIG. 1, the row driver 41 and the demodulation driver 42 are independent configurations, but this is an example, and the row driver 41 and the demodulation driver 42 may be implemented as a single configuration and may be disposed on one side of the pixel array 30.

The light source driver 43 may generate the light modulation signal MLS capable of driving the light source 10 under control of the timing controller 44. The light modulation signal MLS may be a signal modulated with a designated frequency.

The timing controller 44 may generate a timing signal for controlling an operation of the row driver 41, the demodulation driver 42, the light source driver 43, and the readout circuit 45.

The readout circuit 45 may process pixel signals output from the pixel array 30 under the control of the timing controller 44 to generate pixel data in a digital signal form. For example, the readout circuit 45 may perform correlated double sampling (CDS) on the pixel signals output from the pixel array 30. The electronic device 100 may reduce readout noise included in the pixel signals through the CDS. In addition, the readout circuit 45 may include an analog-digital converter (ADC) for converting output signals on which the CDS is performed into digital signals. In addition, the readout circuit 45 may include a buffer circuit for temporarily storing the pixel data output from the ADC and outputting the pixel data to an outside under the control of the timing controller 44.

At least one column line for transferring the pixel signal from the pixels 35 to the readout circuit 45 may be provided for each column of the pixel array 30, and configurations for processing the pixel signal output from each column line may also be provided in correspondence with each column line.

The distance measuring module 50 may receive the pixel data from the readout circuit 45 and determine the distance (or depth) to the external object 1 based on the pixel data. For example, when the light source 10 emits the modulated light modulated with a predetermined frequency toward a scene captured by the electronic device 100 and the electronic device 100 senses reflected light (or incident light) reflected from the external object 1 in the scene, a time delay according to the distance between the electronic device 100 and the external object 1 exists between the modulated light and the reflected light. When a phase of the modulated light corresponds to the first phase, a phase of the reflected light may correspond to a second phase having a predetermined phase difference from the first phase. The distance measuring module 50 may determine the second phase corresponding to the reflected light based on the pixel data. In addition, the distance measuring module 50 may determine the distance to the external object 1 based on the phase difference between the first phase and the second phase. The electronic device 100 may generate a depth image including depth information for each pixel 35 by using the phase difference between the modulated light and the reflected light.

Although not separately shown for the image sensor in FIG. 1, the pixel array 30, the row driver 41, the demodulation driver 42, and the readout circuit 45 among the configurations shown in FIG. 1 may be understood as configurations included in the image sensor.

FIG. 2 is a diagram illustrating an example of a pixel array according to an embodiment of the present disclosure.

The pixel array 200 shown in FIG. 2 may correspond to an example of the pixel array 30 shown in FIG. 1. In addition, each of pixels 211, 212, 213, and 214 shown in FIG. 2 may correspond to the pixel 35 of FIG. 1, respectively.

Referring to FIG. 2, the pixel array 200 may include two or more pixels 211, 212, 213, and 214. For example, a first pixel 211, a second pixel 212, a third pixel 213, and a fourth pixel 214 may be included in the pixel array 200. The first pixel 211, the second pixel 212, the third pixel 213, and the fourth pixel 214 may be arranged in a 2×2 array to form a unit pixel. In the present disclosure, the present disclosure is described on a premise that 4 pixels arranged in a 2×2 array configure one unit pixel, but this is for convenience of description, and the unit pixel may include 2 pixels or include 9 pixels arranged in a 3×3 array.

Referring to FIG. 2, each of the pixels 211, 212, 213, and 214 included in the pixel array 200 may include two taps. For example, the first pixel 211 may include a first tap 221 and a second tap 222. The second pixel 212 may include a third tap 223 and a fourth tap 224. The third pixel 213 may include a fifth tap 225 and a sixth tap 226. The fourth pixel 214 may include a seventh tap 227 and an eighth tap 228. However, a position and a shape of the taps 221, 222, 223, 224, 225, 226, 227, and 228 shown in FIG. 2 are examples, and do not limit the scope of the present disclosure. For example, the first tap 221 and the second tap 222 may be disposed in parallel in a y-axis direction or disposed in a diagonal direction in addition to being disposed in parallel in an x-axis direction. In addition, each of the taps 221, 222, 223, 224, 225, 226, 227, and 228 may be implemented in various shapes other than a circle.

The control circuit 40 (for example, the demodulation driver 42) may provide a modulation voltage to at least one of the pixels 211, 212, 213, and 214 included in the pixel array 200. The control circuit 40 may generate a pixel current in the pixels 211, 212, 213, 214 by providing the modulation voltage to at least one of the pixels 211, 212, 213, 214, and capture the photo charge moving according to the pixel current by using at least one of the taps 221, 222, 223, 224, 225, 226, 227, and 228.

Each of the taps 221, 222, 223, 224, 225, 226, 227, and 228 may include a control node and a detection node. For example, the first tap 221 may include a control node 231 and a detection node 232 surrounding the control node 231. In addition, the second tap 222 may include a control node 233 and a detection node 234 surrounding the control node 233. The control circuit 40 may apply a modulation voltage to the control nodes 231 and 233 and may capture the photo charge through the detection nodes 232 and 234.

The control circuit 40 may provide the modulation voltage to the pixel array 200 in different methods according to a driving mode of the image sensor. The driving mode of the image sensor may include a normal mode and a binning mode. In the present disclosure, the first mode may mean the normal mode, and the second mode may mean the binning mode.

In the first mode, the control circuit 40 may provide a first modulation voltage and a second modulation voltage having a phase difference of 180 degrees from each other to each of the pixels 211, 212, 213, and 214. For example, referring to a cross-sectional view of the first pixel 211 shown at a lower end of FIG. 2, the control circuit 40 may apply a first modulation voltage VmixA to the control node 231 of the first tap 221 and apply a second modulation voltage VmixB to the control node 233 of the second tap 222. When the first modulation voltage VmixA and the second modulation voltage VmixB are applied to the first tap 221 and the second tap 222, respectively, photo charges generated in the first pixel 211 may be captured at the detection node 232 of the first tap 221 and the detection node 234 of the second tap 222 by the pixel current. The readout circuit 45 may measure the distance to the external object 1 by reading out the first tap 221 and the second tap 222.

Similarly, in a case of the second pixel 212, the control circuit 40 may apply the first modulation voltage to the third tap 223 and apply the second modulation voltage to the fourth tap 224. Alternatively, the control circuit 40 may apply the second modulation voltage to the third tap 223 and apply the first modulation voltage to the fourth tap 224. That is, the control circuit 40 may provide the first modulation voltage and the second modulation voltage having different phases to the two taps included in each of the pixels 211, 212, 213, and 214 respectively.

The electronic device 100 may obtain the pixel data corresponding to the number of pixels 35 included in the pixel array 30 by driving the image sensor in the first mode (normal mode). That is, the electronic device 100 may obtain depth image data corresponding to resolution of the pixel array 30 in the first mode. In the present disclosure, pixel data corresponding to the resolution of the pixel array 30 may be referred to as first type of pixel data.

In the second mode, the control circuit 40 may apply the first modulation voltage to any one pixel (for example, the first pixel 211) among the pixels 211, 212, 213, and 214, and apply the second modulation voltage to another pixel (for example, the fourth pixel 214). Instead of providing the first modulation voltage and the second modulation voltage to each of the pixels 211, 212, 213, and 214, the control circuit 40 may provide the first modulation voltage and a second modulation voltage to any two pixels among the pixels included in the unit pixel, respectively. For example, the control circuit 40 may provide the first modulation voltage to the first tap 221 of the first pixel 211 and provide the second modulation voltage to the eighth tap 228 of the fourth pixel 214. At this time, the control circuit 40 may float the remaining taps (for example, 222, 223, 224, 225, 226, and 227) except for the first tap 221 and the eighth tap 228.

When the control circuit 40 applies the first modulation voltage to the first tap 221 of the first pixel 211, applies the second modulation voltage to the eighth tap 228 of the fourth pixel 214, and floats the other taps, a photo charge generated in the first pixel 211, the second pixel 212, the third pixel 213, and the fourth pixel 214 may be captured by the first tap 221 and the eighth tap 228. The readout circuit 45 may measure the distance to the external object 1 by reading out the first tap 221 and the eighth tap 228.

The electronic device 100 may obtain pixel data corresponding to the number less than the number of pixels 35 included in the pixel array 30 by driving the image sensor in the second mode (binning mode). That is, the electronic device 100 may obtain depth image data having resolution lower than resolution of the pixel array 30 in the second mode. For example, when four pixels arranged in a 2×2 array form one unit pixel, the electronic device 100 may obtain depth image data of resolution lower than the resolution of the pixel array 30 by ¼ in the second mode. In the present disclosure, the pixel data corresponding to the resolution lower than the resolution of the pixel array 30 may be referred to as second type of pixel data.

The present disclosure is described on a premise that the control circuit 40 applies the first modulation voltage and the second modulation voltage to the first pixel 211 and the fourth pixel 214 in the second mode with reference to FIG. 2, but this is an example and does not limit the scope of the present disclosure. For example, the control circuit 40 may apply the first modulation voltage and the second modulation voltage to the second pixel 212 and the third pixel 213, respectively, or apply the first modulation voltage and the second modulation voltage to the first pixel 211 and the third pixel 213, respectively. For another example, when two pixels (for example, the first pixel 211 and the second pixel 212) form one unit pixel, the control circuit 40 may apply the first modulation voltage and the second modulation voltage to the first pixel 211 and the second pixel 212, respectively.

FIG. 3 is a diagram illustrating another example of a pixel array according to an embodiment of the present disclosure.

The pixel array 300 shown in FIG. 3 may correspond to another example of the pixel array 30 of FIG. 1. In addition, each of pixels 311, 312, 313, and 314 shown in FIG. 3 may correspond to the pixel 35 of FIG. 1, respectively.

Referring to FIG. 3, the pixel array 300 may include two or more pixels 311, 312, 313, and 314. For example, a first pixel 311, a second pixel 312, a third pixel 313, and a fourth pixel 314 may be included in the pixel array 300. The first pixel 311, the second pixel 312, the third pixel 313, and the fourth pixel 314 may be arranged in a 2×2 array to form a unit pixel.

Referring to FIG. 3, differently from the pixel array 200 shown in FIG. 2, each of pixels (for example, 311, 312, 313, and 314) included in the pixel array 300 may share taps (for example, 321, 322, 323, 324, and 325) with each other. That is, instead of including two taps for each of the pixels 211, 212, 213, 214 as shown in FIG. 2, the taps 321, 322, 323, 324, and 325 may be disposed to correspond to some of vertices of the respective pixels 311, 312, 313, and 314 as shown in FIG. 3. For example, the pixel array 300 may include a first tap 321, a second tap 322, a third tap 323, and a fourth tap 324 disposed to correspond to vertices of the unit pixel, and include a fifth tap 325 disposed inside the unit pixel. The fifth tap 325 may be disposed to correspond to a center of the unit pixel.

The respective pixels 311, 312, 313, and 314 included in the pixel array 300 may have a quadrangular shape, and may include four vertex areas in an upper left side, an upper right side, a lower left side, and a lower right side, respectively. In the present disclosure, the vertex areas positioned on the upper left side, the upper right side, the lower left side, and the lower right side of the respective pixels 311, 312, 313, and 314 are defined as a first vertex area, a second vertex area, a third vertex area, and a fourth vertex area, respectively. In the present disclosure, a vertex area may mean an area including each vertex of a pixel.

The taps 321, 322, 323, 324, and 325 may be disposed in each of two vertex areas (for example, the first vertex area and the fourth vertex area, or the second vertex area and the third vertex area) facing in a diagonal direction in the respective pixels 311, 312, 313, and 314. In this case, a diagonal direction connecting the first vertex area and the fourth vertex area is defined as a first diagonal direction, and a diagonal direction connecting the second vertex area and the third vertex area is defined as a second diagonal direction. Referring to FIG. 3, assuming that the taps (for example, the first tap 321 and the fifth tap 325) are disposed in the first diagonal direction in any one pixel (for example, the first pixel 311), the taps (for example, the second tap 322 and the fifth tap 325) may be disposed in the second diagonal direction in pixels (for example, the second pixel 312) adjacent to top, bottom, left, and right of the pixel (for example, the first pixel 311).

Referring to FIG. 3, in the pixel array 300, the taps 321, 322, 323, 324, and 325 may be sparsely disposed along a row direction or a column direction instead of being disposed at each successive vertex area. That is, a vertex area where a tap is disposed and a vertex area where a tap is not disposed may be alternately disposed along the row direction or the column direction.

Each of taps (for example, the fifth tap 325) included in the pixel array 300 may include a control node (for example, 330) and detection nodes (for example, 331, 332, 333, and 334) surrounding the control node. In FIG. 3, a shape of the control node 330 is exemplified as a circular shape and a shape of the detection nodes 331, 332, 333, and 334 is exemplified as a trapezoidal shape, but the scope of the present disclosure is not limited thereto. In FIG. 3, the detection nodes 331, 332, 333, and 334 may have a trapezoidal shape in which a side adjacent to the control node 330 is shorter than a side opposite to the side. The trapezoidal shape is for each of the detection nodes 331, 332, 333, and 334 to surround the corresponding control node 330 as wide as possible, and the detection nodes 331, 332, 333, and 334 having such a shape may more easily capture a photo charge moving along a pixel current formed by the control node 330.

The control node of each of the taps 321, 322, 323, 324, and 325 may be disposed at a center (or a vertex area of each pixel) of the four pixels 311, 312, 313, and 314 configuring a unit pixel, and the detection nodes may be disposed to face each other along the first diagonal direction or the second diagonal direction with the control node as the center. In addition, the respective detection nodes may be disposed to be included in the respective four pixels adjacent to the control node. For example, the control node 330 of the fifth tap 325 may be disposed at the center of the pixels 311, 312, 313, and 314, and the respective detection nodes 331, 332, 333, and 334 may be disposed to be included in the respective pixels 311, 312, 313, and 314.

As shown in FIG. 3, as the four pixels 311, 312, 313, and 314 share one control node 330, the number of control nodes required in the pixel array 300 may be decreased to ¼ compared to a case where each of the pixels independently includes the control node as shown in FIG. 2. Therefore, power consumption of the image sensor may be decreased and a volume occupied by the taps in the pixel array 300 may be decreased.

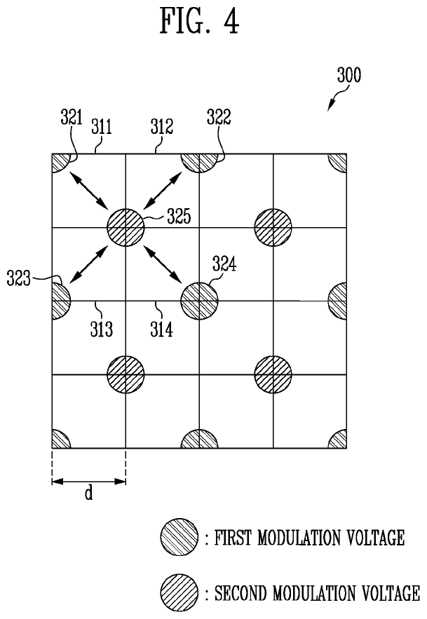

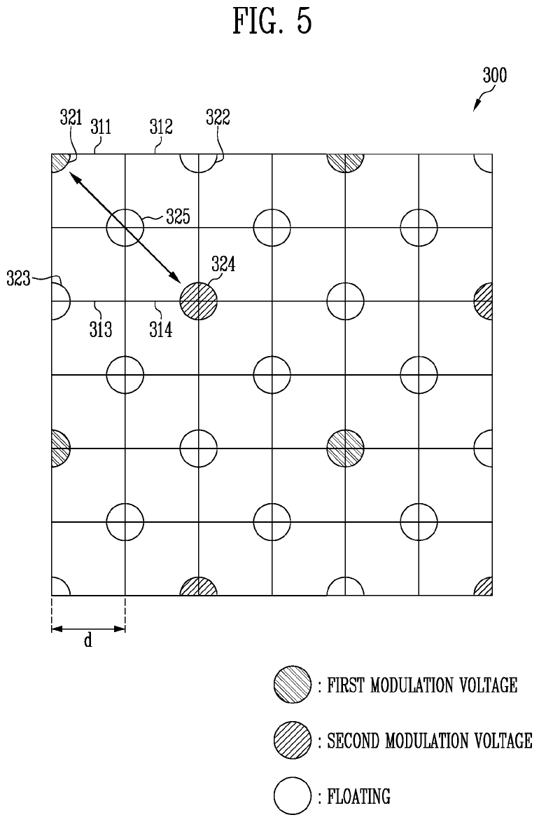

The control circuit 40 may provide the modulation voltage to the pixel array 300 using different methods according to the driving mode of the image sensor. Operation of the control circuit 40 in the first mode (normal mode) and the second mode (binning mode) are described later with reference to FIGS. 4 and 5, respectively.

FIG. 4 is a diagram illustrating a modulation voltage provided to pixels in a first mode according to an embodiment of the present disclosure.

In the first mode, the control circuit 40 may provide the first modulation voltage and the second modulation voltage having the phase difference of 180 degrees to each of the pixels 311, 312, 313, and 314. For example, the control circuit 40 may provide the first modulation voltage to the first tap 321, the second tap 322, the third tap 323, and the fourth tap 324, and provide the second modulation voltage to the fifth tap 325.

In a case of the first pixel 311, when the control circuit 40 applies the first modulation voltage and the second modulation voltage to the first tap 321 and the fifth tap 325, respectively, photo charges generated in the first pixel 311 may be captured at the detection node of the first tap 321 and the detection node 331 of the fifth tap 325 by the pixel current. An arrow shown in FIG. 4 may indicate a direction in which the photo charge moves by the pixel current generated in the pixel. The readout circuit 45 may measure the distance to the external object 1 by reading out the first tap 321 and the fifth tap 325.

Similarly, in a case of the second pixel 312, when the control circuit 40 applies the first modulation voltage and the second modulation voltage to the second tap 322 and the fifth tap 325, respectively, photo charges generated in the second pixel 312 may be captured at the detection node of the second tap 322 and the detection node 332 of the fifth tap 325 by the pixel current. The readout circuit 45 may measure the distance to the external object 1 by reading out the second tap 322 and the fifth tap 325. A corresponding content may also be applied to the third pixel 313 and the fourth pixel 314.

The electronic device 100 may obtain pixel data corresponding to the number of pixels 35 included in the pixel array 30 by driving the image sensor in the first mode (normal mode). That is, the electronic device 100 may obtain the depth image data corresponding to the resolution of the pixel array 30 in the first mode. In the present disclosure, the pixel data corresponding to the resolution of the pixel array 30 may be referred to as the first type of pixel data.

FIG. 5 is a diagram illustrating a modulation voltage provided to pixels in a second mode according to an embodiment of the present disclosure.

In the second mode, the control circuit 40 may provide the first modulation voltage to any one pixel (for example, the first pixel 311) among the pixels 311, 312, 313, and 314, and provide the second modulation voltage to another pixel (for example, the fourth pixel 314). The control circuit 40 may provide the first modulation voltage and the second modulation voltage to any two pixels among pixels included in a unit pixel. For example, the control circuit 40 may provide the first modulation voltage to the first tap 321 disposed in an upper left side vertex area of the first pixel 311 and provide the second modulation voltage to the fourth tap 324 disposed in a lower right side vertex area of the fourth pixel 314. At this time, the control circuit 40 may float the second tap 322, the third tap 323, and the fifth tap 325.

When the control circuit 40 applies the first modulation voltage to the first tap 321, applies the second modulation voltage to the fourth tap 324, and floats the second tap 322, the third tap 323, and the fifth tap 325, a photo charge generated by the first pixel 311, the second pixel 312, the third pixel 313, and the fourth pixel 314 may be captured by the first tap 321 and the fourth tap 324. The readout circuit 45 may measure the distance to the external object 1 by reading out the first tap 321 and the fourth tap 324.

In the present disclosure, the control circuit 40 operating in the second mode may float some of the taps, and this time, floating may mean that a driving signal such as a modulation voltage is not provided to a corresponding tap. When the control circuit 40 applies a modulation voltage to some taps (for example, the first tap 321 and the fourth tap 324), and does not apply the modulation voltage to the remaining taps (for example, the second tap 322, the third tap 323, and the fifth tap 325), the photo charge generated in the unit pixel including the first pixel 311, the second pixel 312, the third pixel 313, and the fourth pixel 314 may be captured by the first tap 321 and the fourth tap 324 and may not be captured by the second tap 322, the third tap 323, and the fifth tap 325. That is, when comparing the first mode shown in FIG. 4 with the second mode shown in FIG. 5, the photo charge moves in the pixel and is captured in the first mode, but the photo charge may cross a boundary of the pixel, may move, and may be captured in the unit pixel in the second mode.

As the electronic device 100 drives the image sensor in the second mode (binning mode), the electronic device 100 may obtain the pixel data corresponding to the number less than the number of pixels 35 included in the pixel array 30. That is, the electronic device 100 may obtain the depth image data having the resolution lower than the resolution of the pixel array 30 in the second mode. For example, when four pixels arranged in a 2×2 array form one unit pixel, the electronic device 100 may obtain depth image data having resolution lower than the resolution of the pixel array 30 by ¼ in the second mode. In the present disclosure, the pixel data corresponding to the resolution lower than the resolution of the pixel array 30 may be referred to as the second type of pixel data.

The existing image sensor provides a modulation voltage to all taps even in a case where the image sensor operates in the binning mode, as in the normal mode. The image sensor applies a first modulation voltage and a second modulation voltage to each of four pixels forming a unit pixel, and reads out all taps to obtain pixel data corresponding to a photo charge captured as the modulation voltage is applied. The image sensor obtains binned depth image data by averaging or summing the pixel data respectively obtained from the four pixels for binning of the pixel data. At this time, a distance between nodes to which the image sensor applies the modulation voltage may correspond to, for example, a distance between the first tap 321 and the fifth tap 325, that is, \sqrt{2}d.

In contrast, according to the present disclosure, in the second mode (binning mode), a distance between nodes (for example, the control node of the first tap 321 and the control node of the fourth tap 324) to which the modulation voltage is applied may be doubled compared to the existing distance. For example, the distance between the nodes to which the control circuit 40 applies the modulation voltage in the second mode may correspond to a distance between the first tap 321 and the fourth tap 324, that is, 2\ddot{2}d.

As the distance between the nodes to which the control circuit 40 applies the modulation voltage becomes shorter, an intensity of a pixel current flowing in the pixel by the modulation voltage may increase. When the pixel current is generated at a level equal to or greater than a certain level, there is a problem in that power consumption of the image sensor (or TOF sensor) increases or efficiency in which a photo charge is captured is decreased compared to a difference between applied voltages. For example, even though the control circuit 40 provides the modulation voltages so that the modulation voltages are different from each other by 1.2V, the voltage difference may be canceled by the pixel current generated in the pixel, and thus capture efficiency may be decreased. Therefore, according to the present disclosure, as the distance between the nodes to which the control circuit 40 applies the modulation voltage in the second mode increases compared to the prior art, the intensity of the pixel current generated in the pixel may be decreased. In addition, as the pixel current flowing in the pixel is decreased, IR drop may be decreased. Therefore, power consumption of the image sensor may be decreased, the efficiency in which the photo charge is captured may be increased, driving performance of the control circuit 40 (for example, the demodulation driver 42) may be improved, and distance measurement performance of the image sensor may be improved. In addition, according to the present disclosure, while maintaining the size of the pixel 35 of the image sensor as d, an effect that the pixel may be decreased as in a case of using a pixel of which a pixel size is 2d in the second mode may appear.

In addition, in the existing image sensor, a digital binning operation of separately averaging or summing after reading out all taps in the second mode is required, but according to the present disclosure, since only some taps to which the modulation voltage is applied are read out, a separate binning operation may be omitted. Accordingly, an effect that hardware related to digital binning may be omitted may also appear.

Regarding the second mode (binning mode) described with reference to FIGS. 2 and 5, an embodiment in which the control circuit 40 floats the taps to which the first modulation voltage or the second modulation voltage is not provided is described, but in addition to this embodiment, various embodiments are possible. For example, the control circuit 40 may apply Vss or apply a voltage of a specific intensity instead of floating a tap other than the taps to which the modulation voltage is applied in FIG. 2, or the second tap 322, the third tap 323, and the fifth tap 325 of FIG. 5.

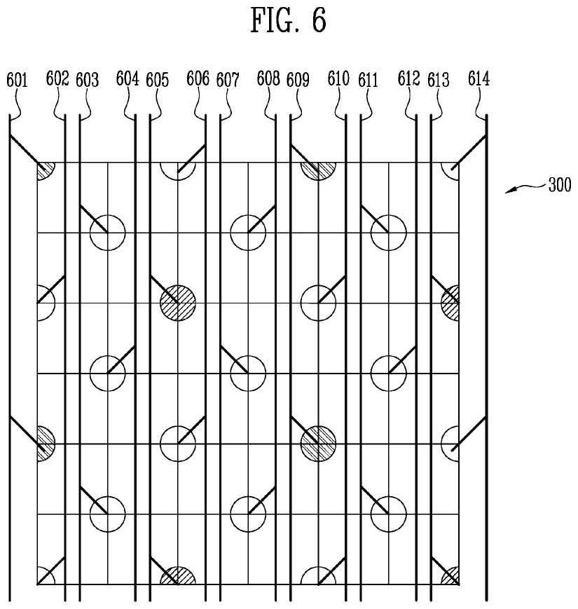

FIG. 6 is a diagram illustrating a signal line transferring a modulation voltage to pixels according to an embodiment of the present disclosure.

FIG. 6 shows an example of signal lines that are used in the pixel array 300 for the control circuit 40 to operate in the method described with reference to FIG. 5. A content described with reference to FIG. 6 corresponds to one example of signal lines for a second mode (binning mode) operation according to the present disclosure, and thus does not limit the scope of the present disclosure.

The control circuit 40 (for example, the demodulation driver 42) may generate and output the drive signal for generating the pixel current (for example, the hole current) in the substrate of the pixel array 300. The demodulation driver 42 may generate the modulation voltage to be applied to the pixels included in the pixel array 300. The demodulation driver 42 may provide the generated modulation voltage to the pixels using at least one signal line for each column of the pixel array 300.

Referring to FIG. 6, the control circuit 40 (for example, the demodulation driver 42) may provide the modulation voltage to the pixels through at least a portion of signal lines 601, 602, 603, 604, 605, 606, 607, 608, 609, 610, 611, 612, 613, and 614. For example, the image sensor may include two signal lines disposed for each column of the pixel array 300. The demodulation driver 42 may apply the modulation voltage to the taps through the signal lines.

In the first mode, the control circuit 40 (for example, the demodulation driver 42) may transfer the first modulation voltage to the taps through the signal lines 601, 602, 605, 606, 609, 610, 613, and 614, and transfer the second modulation voltage to the taps through the signal lines 603, 604, 607, 608, 611, and 612.

In the second mode, the control circuit 40 (for example, the demodulation driver 42) may transfer the first modulation voltage to the taps (for example, the first tap 321) through the signal lines 601 and 609, and transfer the second modulation voltage to the taps (for example, the fourth tap 324) through the signal lines 605 and 613. In the second mode, the control circuit 40 (for example, the demodulation driver 42) may not transfer the modulating voltage through the signal lines 602, 603, 604, 606, 607, 608, 610, 611, 612, and 614.

It may be understood that FIG. 6 shows an aspect in which the control circuit 40 outputs the first modulation voltage and the second modulation voltage in the second mode. According to the present disclosure, the control circuit 40 may provide the modulation voltage to a portion of the taps on the same vertical line and not provide the modulation voltage to another portion of the taps on the same vertical line in the second mode. For example, referring to FIG. 5, the control circuit 40 may provide the first modulation voltage to the first tap 321 and not provide the modulation voltage to the third tap 323, among the first tap 321 and the third tap 323 disposed on the same vertical line. Therefore, two signal lines may be disposed for each column in the pixel array 300.

The signal lines 601, 602, 603, 604, 605, 606, 607, 608, 609, 610, 611, 612, 613, and 614 described with reference to FIG. 6 may be a configuration disposed separately from a column line through which the readout circuit 45 reads out the pixels of the pixel array 300.

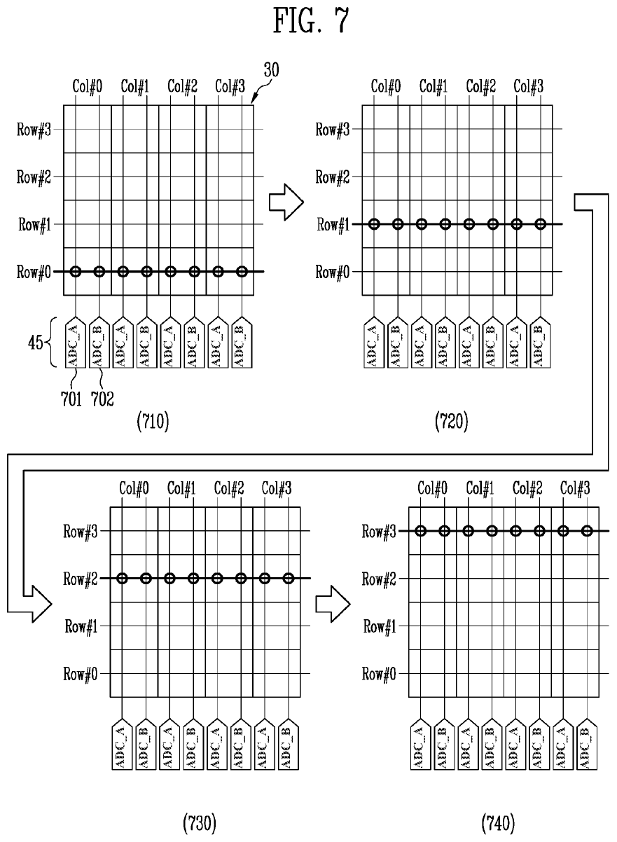

FIG. 7 is a diagram illustrating a method of reading out pixels in a first mode according to an embodiment of the present disclosure.

The readout circuit 45 may read out one row selected by the row driver 41 among a plurality of rows included in the pixel array 30. Referring to FIG. 7, the readout circuit 45 may include a plurality of analog-digital converters (ADCs). The ADCs included in the readout circuit 45 may be disposed so that two ADCs are connected for each column of the pixel array 30. For example, when the pixel array 30 has the same structure as the pixel array 200 of FIG. 2, it may be understood that ADC_A 701 and ADC_B 702 are connected to the detection node 232 of the first tap 221 and the detection node 234 of the second tap 222, respectively. For another example, when the pixel array 30 has the same structure as the pixel array 300 of FIG. 3, it may be understood that the ADC_A 701 is connected to the detection node included in the first pixel 311 and the ADC_B 702 is connected to the detection node 331 of the fifth tap 325 among the detection nodes of the first tap 321.

Referring to reference number 710, the row driver 41 may select any one row line (for example, Row #0) in the pixel array 30, and the readout circuit 45 may read out pixels (or taps) corresponding to the selected row line (for example, Row #0). Referring to reference number 720, the row driver 41 may select any one row line (for example, Row #1) in the pixel array 30, and the readout circuit 45 may read out pixels (or taps) corresponding to the selected row line (for example, Row #1). Similarly, referring to reference number 730, the row driver 41 may select any one row line (for example, Row #2) in the pixel array 30, and the readout circuit 45 may read out pixels (or taps) corresponding to the selected row line (for example, Row #2). Similarly, referring to reference number 740, the row driver 41 may select any one row line (for example, Row #3) in the pixel array 30, and the readout circuit 45 may read out pixels (or taps) corresponding to the selected row line (for example, Row #3).

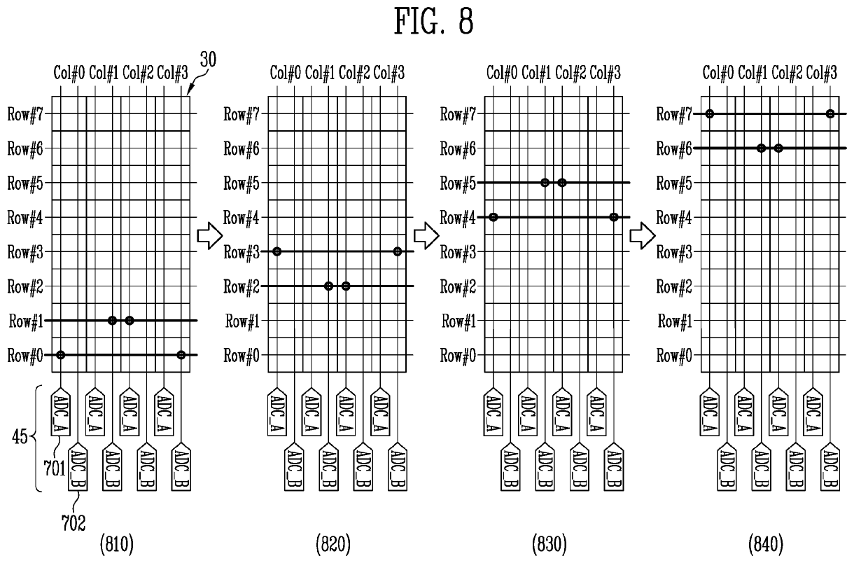

FIG. 8 is a diagram illustrating a method of reading out pixels in a second mode according to an embodiment of the present disclosure.

The readout circuit 45 may read out one or more rows selected by the row driver 41 among the plurality of rows included in the pixel array 30. For example, in the second mode, the readout circuit 45 may read out two rows selected by the row driver 41 among the plurality of rows together.

Referring to reference number 810, the row driver 41 may select two successive row lines (for example, Row #0 and Row #1) in the pixel array 30, and the readout circuit 45 may read out pixels (or taps) corresponding to the selected row lines (for example, Row #0 and Row #1). At this time, the readout circuit 45 may read out only a partial tap (or detection node) instead of reading out all taps (or detection nodes) included in the selected row lines (for example, Row #0 and Row #1). For example, in reference number 810, among 8 taps (or detection nodes) included in 4 pixels corresponding to Row #0, Row #1, Col #0, and Col #1, the readout circuit 45 may read out only two taps (or detection nodes). The two taps (or detection nodes) read out by the readout circuit 45 may correspond to taps (or detection nodes) in which a photo charge is captured as the modulation voltage is applied. Also in reference numbers 820, 830, and 840, the contents described with reference to reference number 810 may be applied, except that row lines selected by the row driver 41 is changed.

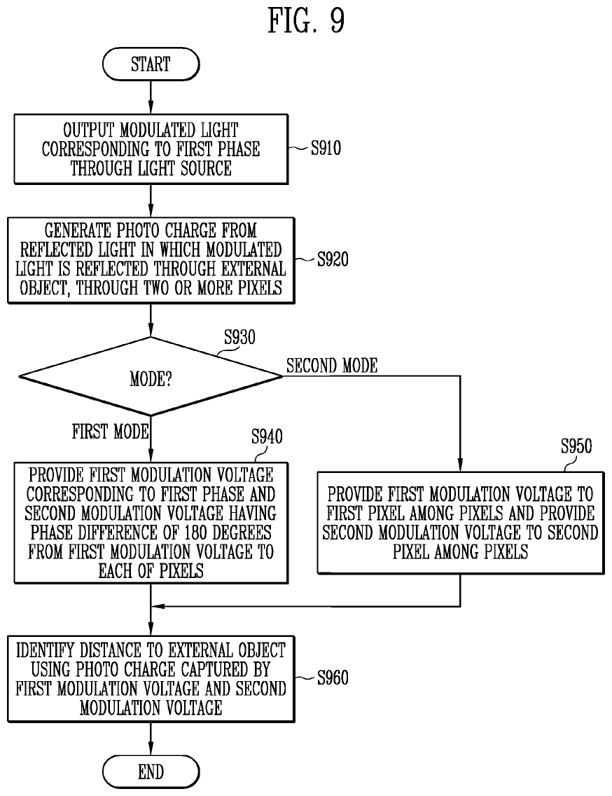

FIG. 9 is a diagram illustrating a flow of a method of providing a modulation voltage in different methods according to a mode according to an embodiment of the present disclosure. Steps described with reference to FIG. 9 may be understood to be performed by the electronic device 100 or the image sensor included in the electronic device 100.

In step S910, the electronic device 100 may output the modulated light corresponding to the first phase through the light source 10.

In step S920, the electronic device 100 may generate a photo charge from the reflected light in which the modulated light is reflected by the external object 1 through two or more pixels. For example, when the reflected light is incident on the pixel array 30 (for example, the pixel array 200 or the pixel array 300), a photo charge proportional to an intensity of the reflected light may be generated in the substrate.

In step S930, the electronic device 100 may determine a driving mode of the image sensor (or TOF sensor). For example, the electronic device 100 may determine whether to drive the image sensor in the first mode (normal mode) or the second mode (binning mode). The electronic device 100 may determine the driving mode of the image sensor in consideration of various conditions such as an imaging environment (for example, illumination), a zoom magnification, required accuracy of distance measurement, and the like.

In step S940, the electronic device 100 may provide the first modulation voltage corresponding to the first phase to each of the pixels in the first mode (normal mode) and provide the second modulation voltage having the phase difference of 180 degrees from the first modulation voltage. For example, the electronic device 100 may apply the first modulation voltage and the second modulation voltage to each pixel so that the photo charge is moved and captured in each pixel.

In step S950, the electronic device 100 may provide the first modulation voltage to a first pixel among the pixels and provide the second modulation voltage to a second pixel among the pixels in the second mode. For example, the electronic device 100 may provide the first modulation voltage to any one pixel among two or more pixels included in the unit pixel and provide the second modulation voltage to another pixel.

In step S960, the electronic device 100 may determine the distance to the external object 1 using the photo charge captured by the first modulation voltage and the second modulation voltage. The electronic device 100 may calculate the phase difference between the modulated light and the reflected light using the pixel data corresponding to the captured photo charge, and measure the distance to the external object 1 using the phase difference.

What is claimed is:

1. An image sensor comprising:
at least two pixels; and
a control circuit configured to:
provide a first modulation voltage and a second modulation voltage having a phase difference of 180 degrees from each other to each of the at least two pixels in a first mode; and
provide the first modulation voltage to a first pixel among the at least two pixels and provide the second modulation voltage to a second pixel among the at least two pixels in a second mode.

2. The image sensor of claim 1, wherein the at least two pixels comprise a unit pixel including 4 pixels arranged in a two-by-two (2×2) array.

3. The image sensor of claim 2, further comprising:
a first tap, a second tap, a third tap, and a fourth tap disposed to correspond to a first vertex, a second vertex, a third vertex, and a fourth vertex, respectively, of the unit pixel; and
a fifth tap disposed inside the unit pixel.

4. The image sensor of claim 3, wherein the control circuit is configured to:
provide the first modulation voltage to the first tap, the second tap, the third tap, and the fourth tap and provide the second modulation voltage to the fifth tap in the first mode; and
provide the first modulation voltage to the first tap and provide the second modulation voltage to the fourth tap in the second mode.

5. The image sensor of claim 4, wherein the control circuit is configured to float the second tap, the third tap, and the fifth tap in the second mode.

6. The image sensor of claim 4, wherein the image sensor is configured so that:
each photo charge generated in the four pixels is captured by any one tap among the first tap, the second tap, the third tap, or the fourth tap and the fifth tap in the first mode; and
each photo charge is captured by the first tap and the fourth tap in the second mode.

7. The image sensor of claim 6, further comprising a readout circuit configured to:
obtain first type of pixel data corresponding to the photo charge captured at the first tap, the second tap, the third tap, the fourth tap, and the fifth tap in the first mode; and
obtain second type of pixel data corresponding to the photo charge captured in the first tap and the fourth tap in the second mode.

8. The image sensor of claim 2, wherein the first pixel and the second pixel are disposed to correspond to vertices positioned in a diagonal direction from each other among vertices of the unit pixel.

9. The image sensor of claim 1, further comprising:
a first tap and a second tap disposed in the first pixel; and
a third tap and a fourth tap disposed in the second pixel.

10. The image sensor of claim 9, wherein the control circuit is configured to:
provide the first modulation voltage to the first tap and the third tap and provide the second modulation voltage to the second tap and the fourth tap in the first mode; and
provide the first modulation voltage to the first tap and provide the second modulation voltage to the fourth tap in the second mode.

11. The image sensor of claim 10, wherein the control circuit is configured to float the second tap and the third tap in the second mode.

12. A distance measuring method comprising:
outputting modulated light corresponding to a first phase through a light source;
generating a photo charge from reflected light in which the modulated light is reflected by an external object, through at least two pixels;
providing a first modulation voltage corresponding to the first phase and a second modulation voltage having a phase difference of 180 degrees from the first modulation voltage to each of the at least two pixels in a first mode, or providing the first modulation voltage to a first pixel among the at least two pixels and providing the second modulation voltage to a second pixel among the at least two pixels in a second mode, according to a mode; and
determining a distance to the external object using the photo charge captured by the first modulation voltage and the second modulation voltage.

13. The distance measuring method of claim 12, wherein providing the first modulation voltage and the second modulation voltage according to the first mode or the second mode comprises:
providing the first modulation voltage to a first tap, a second tap, a third tap, and a fourth tap and providing the second modulation voltage to a fifth tap in the first mode; and
providing the first modulation voltage to the first tap and providing the second modulation voltage to the fourth tap in the second mode, using a unit pixel including 4 pixels arranged in a two-by-two (2×2) array, the first tap, the second tap, the third tap, and the fourth tap disposed to correspond to respective vertices of the unit pixel, and the fifth tap disposed inside the unit pixel.

14. The distance measuring method of claim 13, wherein determining the distance using the captured photo charge comprises:
capturing each photo charge generated in the four pixels by any one tap among the first tap, the second tap, the third tap, or the fourth tap and the fifth tap in the first mode;
obtaining first type of pixel data corresponding to the photo charge captured at the first tap, the second tap, the third tap, the fourth tap, and the fifth tap through a readout circuit; and
determining the distance using the first type of pixel data.

15. The distance measuring method of claim 13, wherein determining the distance using the captured photo charge comprises:
capturing the photo charge generated in the unit pixel by the first tap and the fourth tap in the second mode;
obtaining second type of pixel data corresponding to the photo charge captured at the first tap and the fourth tap through a readout circuit; and
determining the distance using the second type of pixel data.
